(19) United States
(12) Patent Application Publication
(10) Pub. No.: US 2022/0325040 A1
(43) Pub. Date: Oct. 13, 2022

(54) A WATER-SOLUBLE CO-POLYESTER POLYMER AND A PROCESS OF SYNTHESIS THEREOF

(71) Applicants: Akshay Narayan Maikap, Indore (IN); Tanushree Maikap, Indore (IN)

(72) Inventors: Akshay Narayan Maikap, Indore (IN); Tanushree Maikap, Indore (IN)

(21) Appl. No.: 17/641,041

(22) PCT Filed: Sep. 25, 2019
(86) PCT No.: PCT/IB2019/058112

§ 371 Date: Mar. 7, 2022

(30) Foreign Application Priority Data
Sep. 7, 2019 (IN) 201921036126

(51) Int. Cl. C08G 63/20

(52) U.S. Cl. CPC C08G 63/20

(57) ABSTRACT

The present invention relates to a water-soluble co-polyester polymer. The polymer of the present invention is used for inline coating of BOPET film manufacturing, coating of BOPET film used as primer for vacuum metallization and surface coating of Aluminum sheets. The polymer of the present invention provides wide range of printability performances and high metal to film bond strength with minimum gain in weight. The disclosed polymer also provides Tape Test resistant printing and retort resistant layered/composite film.

### FIELD OF THE INVENTION

The present invention relates to co-polyester polymer. Particularly, the present invention relates to water-soluble co-polyester polymer. Specifically, the present invention relates to water-soluble co-polyester polymer used for substrate coating. The process of synthesis is also disclosed.

### BACKGROUND OF THE INVENTION

Biaxially oriented polyethylene terephthalate (BOPET) is a polyester film made from stretched polyethylene terephthalate (PET) and is used for its high tensile strength, chemical and dimensional stability, transparency, reflectivity, gas and aroma barrier properties, and electrical insulation. The manufacturing process begins with a resin of molten polyethylene terephthalate (PET) being extruded onto a chill roll, which quenches it into the amorphous state. It is then biaxially oriented by drawing under special thermal condition, which causes molecular relaxation. The most common way of doing this is the sequential process, in which the film is first drawn in the machine direction using heated rollers and subsequently drawn in the transverse direction, i.e. orthogonally to the direction of travel, in a heated oven. It is also possible to draw the film in both directions simultaneously, although the equipment required for this is somewhat more elaborate. The temperature, orientation, and crystallinity percentage governs the final properties of the BOPET films.

This biaxially oriented film design is largely employed to the packaging material for developing packaging products. The surface energy of the biaxially oriented polyethylene terephthalate (BOPET) films is very less 44-46 Dyne/cm and it's adhesion to ink (printing) or metallized Aluminum is very less, which makes it less suitable for printing or Aluminum metallization. Generally, the BOPET films are either corona treated or coated with other co-polyester polymers to increase their surface energy. The corona treated surface of the BOPET base film degrades during placement or use. If the temperature and humidity are high, the degradation will be faster. Further, the coating polymers are mostly solvent-based and thus, the evaporation of these solvents harm the environment. Many efforts have been done so far to obtain a water-based co-polyester polymer, which can obviate the drawbacks of prior-art and will provide an environmental friendly solution to the problem. Similarly, there is no polymer is disclosed which can provide wide range of printability performance when coated over BOPET or Aluminum sheets.

Therefore, there is an urgent need for inventing and developing a water-soluble polymer which when coated to BOPET film provide increase in surface energy along with wide range of printability performances and high metal to film bond strength with minimum gain in weight. Further, there is an unmet need to invent and develop a water-soluble polymer, which can be used to coat Aluminum sheets to impart wide range of printability performance to it with minimum gain in weight. There exists also an unmet need of a polymer, which can provide retort resistant printing in packaging industry.

### SUMMARY OF THE INVENTION

A water-soluble co-polyester polymer used for substrate coating is provided.

In one aspect, the present invention provides a water-soluble co-polyester polymer, which can be used for inline or offline coating of substrate to increase their surface energy and surface adhesion.

In one another aspect, the present invention provides a water-soluble co-polyester polymer, which can be used for inline or offline coating of substrate provide wide range of printability performance.

In one another aspect, the present invention provides a water-soluble co-polyester polymer which when inline coated on BOPET films enhance their surface properties by increasing number of free functional group for further reaction, provides wide range of printability performance and metal to film bond strength when vacuum Aluminum metallized on coated side.

In one aspect, the present invention provides a water-soluble co-polyester polymer which when coated metal sheets or foil (e.g. Aluminum) enhance the compatibility and hence adhesion of ink, provide wide range of printability performance.

In one another aspect, the present invention provides a water-soluble co-polyester polymer, which imparts excellent adhesion, and printability properties to the substrate when coated with the water-soluble co-polyester polymer.

In one another aspect, the present invention provides a water-soluble co-polyester polymer, which provides excellent film adhesion to ink and Aluminum (metallization) when the BOPET is coated with the water-soluble co-polyester polymer. Thus, it provides wide range of printability performance over the BOPET inline coated with the co-polyester polymer of the present invention. Similarly, the inline coating of BOPET with the co-polyester polymer of the present invention also increases adhesion to Aluminum metal in the process of vacuum metallization and thus provide excellent metal to film bond strength.

In one another aspect, the present invention provides a water-soluble co-polyester polymer, which provides a retort resistant packaging solution for retort packaging.

In one another aspect, the present invention provides a water-soluble co-polyester polymer, which can be coated in very thin layer thickness and at very less weight gain.

In one another aspect, the present invention provides a water-soluble co-polyester polymer for substrate coating, which provides a wide range of printability performance with water-based ink systems, thus avoiding solvent-based ink systems.

In one another aspect, the present invention provides an environment friendly solution to the packaging industry.

In yet another aspect, the present method provides a process of synthesis of the water-soluble co-polyester polymer.

Various aspects of the invention will now be described herein in detail. Still other aspects, features, and advantages of the present invention are readily apparent from the entire description thereof, including the embodiments, examples and implementations. Any subject matter described in the specification can be combined with any other subject matter in the specification to form a novel combination. The invention is also capable of other and different examples and aspects, and its several details can be modified in various respects, all without departing from the spirit and scope of the present invention. Accordingly, the descriptions are to be regarded as illustrative in nature, and not as restrictive. Furthermore, the terminology and phraseology used herein is solely used for descriptive purposes and should not be construed as limiting in scope.

### DETAILED DESCRIPTION OF THE INVENTION

### Abbreviations

BOPET: Biaxially oriented polyethylene terephthalate

PTA: Pure terephthalic acid

IPA: Isophthalic acid

SA: Sebacic acid

BDO: 1,4-Butane diol

NPG: Neopentyl Glycol

TMA: Trimellitic acid

UOM: Unit of measurement

GSM: Gram per square meter

Min: Minute(s)

Hr/hr: Hour(s)

° C.: Degree Centigrade

GSM: Gram per square meter

### Definitions

It is to be understood that the terminology used herein is for the purpose of describing particular embodiments only, and is not intended to be limiting. As used in this specification and the appended claims, the singular forms “a,” “an” and “the” include plural referents unless the context clearly dictates otherwise. Thus, for example, reference to “monomer” includes one or more such monomers and the like.

Unless defined otherwise, all technical, scientific or other terms used herein have the same meaning as commonly understood by one of ordinary skill in the art to which the invention pertains. Although other methods and materials similar, or equivalent, to those described herein can be used in the practice of the present invention, the preferred materials and methods are described herein.

In describing and claiming the present invention, the following terminology will be used in accordance with the definitions set out below.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The term “including” or “Including but not limited to” are used interchangeably. The term “oligomer content” refers to a molecule of intermediate relative molecular mass, the structure of which essentially comprises a small plurality of units derived, actually or conceptually, from molecules of lower relative molecular mass. Short and is determined by Soxhlet reflux method as described in the example section of the present disclosure.

The terms “water-soluble co-polyester polymer”, “polymer”, “co-polyester polymer” or “the polymer of the present invention” are used interchangeably and refer to the water-soluble co-polyester polymer discloses in the present invention.

The term “monomer” refers to a single molecule or unit which when go with similar monomer or different monomer for polymerization synthesizes a polymer.

The term “pre-polymer” refers to a monomer or system of monomers that have been reacted to an intermediate molecular mass state. This material is capable of further polymerization by reactive groups to a fully cured high molecular weight state. As such, mixtures of reactive polymers with un-reacted monomers may also be referred to as pre-polymers.

The term “reaction product” refers to an intended and/or probable resulting product of a chemical reaction under given reaction conditions/parameters e.g. time, temperature and other conditions/parameters.

The term “dicarboxylic acid” refers to an organic compound containing two carboxyl functional groups (—COOH). The term includes the esters/carboxylates of dicarboxylic acids. The dicarboxylic acid used in the present invention can be an aliphatic dicarboxylic acid, an aliphatic dicarboxylate, a cycloaliphatic dicarboxylic acid, a cycloaliphatic dicarboxylate, an aromatic dicarboxylic acid and an aromatic dicarboxylate. The non-exhaustive list of such dicarboxylic acids comprises isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid and suberic acid.

The term “diol” refers to a chemical compound containing two hydroxyl group. The term includes an aliphatic diol, a cycloaliphatic diol and an aromatic diol. The non-exhaustive list of such diols comprises ethylene glycol, diethylene glycol, 1,2-propanediol, 1,3-propaneol, butane diol, 1,3-butanediol, 1,4-butanediol, 1,5-pentanediol, hexane diol, 1,6-hexanediol, cyclohexanedimethanol, 1,4-cyclohexanedimethanol, neopentyl glycol, diethylene glycol, polyethylene glycol, polypropylene glycol, polytetramethylene glycol, bisphenol A and bisphenol S.

The term “tricarboxylic acid” refers to a chemical compound containing three hydroxyl group. The non-exhaustive list of such tricarboxylic acid comprises 2-hydroxypropane-1,2,3-tricarboxylic acid, 1 -hydroxypropane-1,2,3 -tricarboxylic acid, prop-1-ene-1,2,3 -tricarboxylic acid, propane-1,2,3-tricarboxylic acid, benzene-1,3,5-tricarboxylic acid, 1,2,3-benzene tricarboxylic acid, pentane 1,3,5-tricarboxylic acid, biphenyl 3,4,5 tricarboxylic acid, trimellitic acid, butane 1,2,4-tricarboxylic acid, and benzene-1,2,4-tricarboxylic acid.

The term “intrinsic viscosity” (I.V.) refers to a measure of a solute's contribution to the viscosity of a solution. I.V. as used herein is measured by dilute solution using an Ubbelohde capillary viscometer.

The term “carboxylic end group content” refers to —COOH end group present at the end of polymer chains and is determined by the method described in the example section of the present disclosure.

The terms “glass transition temperature” and “T_{g}” can be used interchangeably and refer to the temperature at which a chemical compound specifically polymers turn from a ductile and soft material to a hard, brittle or glass like material.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 mole % should be interpreted to include not only the explicitly recited limits of 5 to 40 mole %, but also to include sub-ranges, such as 10 mole % to 30 mole %, 7 mole % to 25 mole %, and so forth, as well as individual amounts, including fractional amounts, within the specified ranges, such as 15.5 mole %, 29.1 mole %, and 12.9 mole %.

### I. A Water-Soluble Co-Polyester Polymer

The present invention discloses a co-polyester polymer. Particularly, a water-soluble co-polyester polymer is disclosed. Specifically, a water-soluble co-polyester polymer used for substrate coating is disclosed. The process of synthesis is also disclosed.

In one embodiment, the present invention discloses a water-soluble co-polyester polymer used for substrate coating is provided.

In one another embodiment, the present invention discloses a water-soluble co-polyester polymer, which can be used for inline or offline coating of substrate to increase their surface energy and surface adhesion.

In one another embodiment, the present invention provides a water-soluble co-polyester polymer, which can be used for inline or offline coating of substrate provide wide range of printability performance.

In one another embodiment, the present invention provides a water-soluble co-polyester polymer which when inline coated on BOPET films enhance their surface energy, provide wide range of printability performance and metal to film bond strength.

In one another embodiment, the present invention provides a water-soluble co-polyester polymer, which imparts excellent adhesion, and printability properties to the substrate when coated with the water-soluble co-polyester polymer.

In one another embodiment, the present invention provides a water-soluble co-polyester polymer, which provides excellent film adhesion to ink and Aluminum (metallization) when the BOPET is coated with the water-soluble co-polyester polymer. Thus, it provides wide range of printability performance over the BOPET inline coated with the co-polyester polymer of the present invention. Similarly, the inline coating of BOPET with the co-polyester polymer of the present invention also increases adhesion to Aluminum metal in the process of metallization and thus provide excellent metal to film bond strength.

In one another embodiment, the present invention provides a water-soluble co-polyester polymer, which provides a retort resistant packaging solution for retort packaging.

In one another embodiment, the present invention provides a water-soluble co-polyester polymer, which can be coated in very thin layer thickness and at very less weight gain.

In one another embodiment, the present invention provides a water-soluble co-polyester polymer for substrate coating, which provide a wide range of printability performance with water-based ink systems, thus avoiding solvent-based ink systems.

In one another embodiment, the present invention provides an environment friendly solution to the packaging industry.

The present invention discloses a water-soluble co-polyester polymer; the polymer comprises a) a pre-polymer (A); and b) a tricarboxylic acid; wherein, the pre-polymer (A) comprises a transesterification reaction product of a dicarboxylic acid or ester thereof with a diol.

The dicarboxylic acid or ester thereof is selected from an aliphatic dicarboxylic acid, an aliphatic dicarboxylate, a cycloaliphatic dicarboxylic acid, a cycloaliphatic dicarboxylate, an aromatic dicarboxylic acid, an aromatic dicarboxylate or any combination thereof. The non-limiting examples of dicarboxylic acids include isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid, suberic acid or any combination thereof. Preferably, the dicarboxylic acid is selected from isophthalic acid, dimethyl isophthalate, terephthalic acid, dimethyl terephthalate and any combination thereof.

In some embodiments, the dicarboxylic acid is isophthalic acid. In some embodiments, the dicarboxylic acid is terephthalic acid. In some embodiments, the dicarboxylic acid is sebacic acid. In some embodiments, the dicarboxylic acid is a combination of isophthalic acid, terephthalic acid and sebacic acid.

In some preferred embodiments, the dicarboxylic acid is a combination of isophthalic acid, terephthalic acid and sebacic acid.

The diol is selected from an aliphatic diol, a cycloaliphatic diol, an aromatic diol and any combination thereof. The non-limiting examples of first diols include ethylene glycol, diethylene glycol, 1,2-propanediol, 1,3-propaneol, butane diol, 1,3-butanediol, 1,4-butanediol, 1,5-pentanediol, hexane diol, 1,6-hexanediol, cyclohexanedimethanol, 1,4-cyclohexanedimethanol, neopentyl glycol, diethylene glycol, polyethylene glycol, polypropylene glycol, polytetramethylene glycol, bisphenol A., bisphenol S. or any combination thereof.

In some embodiments, the diol is ethylene glycol. In some embodiments, the diol is butane diol. In some embodiments, the diol is neopentyl glycol. In some embodiments, the diol is a combination of ethylene glycol, butane diol and neopentyl diol.

In some preferred embodiments, the diol is a combination of ethylene glycol, butane diol and neopentyl diol.

In some embodiments, the pre-polymer (A) comprises a transesterification reaction product of a dicarboxylic acid or ester thereof with a diol; wherein the carboxylic acid is a combination of isophthalic acid, terephthalic acid and sebacic acid; and the diol is a combination of ethylene glycol, 1,4-butanediol and neopentyl glycol.

The tricarboxylic acid is selected from an aliphatic tricarboxylic acid, a cycloaliphatic tricarboxylic acid, an aromatic tricarboxylic acid or any combination thereof. The non-exhaustive list of such tricarboxylic acid comprises 2-hydroxypropane-1,2,3-tricarboxylic acid, 1-hydroxypropane-1,2,3-tricarboxylic acid, prop-1-ene-1,2,3 -tricarboxylic acid, propane-1,2,3-tricarboxylic acid, benzene-1,3,5-tricarboxylic acid, 1,2,3-benzene tricarboxylic acid, pentane 1,3,5-tricarboxylic acid, biphenyl 3,4,5 tricarboxylic acid, trimellitic acid butane 1,2,4-tricarboxylic acid, and benzene-1,2,4-tricarboxylic acid or any combination thereof.

In some embodiments, the tricarboxylic acid is trimellitic acid.

In some preferred embodiments, the tricarboxylic acid is trimellitic acid.

It is understood that each description of dicarboxylic acid may be combined with each description of the diol the same as if each and every combination were specifically and individually listed. Similarly, it is understood that each description of tricarboxylic acid be combined with each description of the pre-polymer (A) (each description of the dicarboxylic acid with each description of the diol) the same as if each and every combination were specifically and individually listed.

The water-soluble co-polyester polymer disclosed herein are used to coat one or more substrates. The substrates include but not limited to BOPET film, BOPET primer for metallization and Aluminum sheets.

The polymer of the present invention can be coated on the BOPET film during inline manufacturing process. The coating can also be done offline while coating on Aluminum sheets.

The polymer of the present invention imparts excellent surface characteristics to the coated surface e.g. increased more number of functional group on film surface for further reaction, adhesion, printability, metal to film bond strength etc. The polymer of the present invention also coats the surface very efficiently in minimum weight gain.

The surface coated with the polymer disclosed in the present invention can be printed using a wide range of ink systems e.g. water-based inks and solvent-based ink system. The polymer of the present invention is also used with the UV curable inks to coat the surface of the substrates.

The polymer of the present invention exhibits an intrinsic viscosity (I.V.) from about 0.1 to 0.5 dL/g. Preferably, the polymer of the present invention exhibits an intrinsic viscosity (I.V.) from about 0.1 to 0.45 dL/g. More specifically, the polymer of the present invention exhibits an intrinsic viscosity (I.V.) from about 0.1 to 0.4 dL/g.

The polymer of the present invention exhibits a carboxylic content from 30 to 900 meq/Kg. Preferably, the polymer of the present invention exhibits a carboxylic content from 30 to 850 meq/Kg. More preferably, the polymer of the present invention exhibits a carboxylic content from 30 to 800 meq/Kg.

The polymer of the present invention exhibits a glass transition temperature from 30° C. to 50° C. Preferably, the polymer of the present invention exhibits a glass transition temperature from 30° C. to 45° C. More preferably, the polymer of the present invention exhibits a glass transition temperature from 30° C. to 40° C.

The polymer of the present invention when coated over a 12 micron BOPET film in inline manufacturing process, the coating is done at a coating thickness from 0.01 to 0.09 GSM. Preferably, the coating is done at a coating thickness from 0.01 to 0.08 GSM. More preferably, the coating is done at a coating thickness from 0.01 to 0.07 GSM.

The polymer of the present invention when coated over a 12 micron BOPET film at a coating thickness from 0.01 to 0.09 GSM and then the coated BOPET film is printed, the coated and printed BOPET film exhibits resistance to ink adhesion test in Tape Test after sustaining boiling water test for 2 hr. Preferably, the coated and printed BOPET film exhibits resistance to ink adhesion test in Tape Test after sustaining boiling water test for 1 hr. More preferably, the coated and printed BOPET film exhibits resistance to ink adhesion test in Tape Test after sustaining boiling water test for 0.5 hr.

The polymer of the present invention when coated over a 12 micron BOPET film at a coating thickness from 0.01 to 0.09 GSM, then the coated BOPET film is vacuum metallized with an optical density from 0.5 to 3.2. Preferably, the coated BOPET film is vacuum metallized with an optical density from 1.5 to 3.2. More preferably, the coated BOPET film is vacuum metallized with an optical density from 1.8 to 3.2.

The polymer of the present invention when coated over a 12 micron BOPET film at a coating thickness from 0.01 to 0.09 GSM and then the coated BOPET film is metallized with Aluminum; the coated and metallized BOPET film exhibits a metal to film bond strength from 800 g/inch to 1200 g/inch. Preferably, the coated and metallized film exhibits a metal to film bond strength from 800 g/inch to 1100 g/inch. More preferably, the metallized film exhibits a metal to film bond strength from 800 g/inch to 1000 g/inch.

The polymer of the present invention when coated over a 12 micron BOPET film at a coating thickness from 0.01 to 0.09 GSM and then the coated BOPET film is printed with various retort ink(s), the printed film is then subjected to lamination with Aluminum foil, retort cast polypropylene film, nylon film and with retort adhesive sequentially to make composite film, the resulted layered/composite film exhibits no delamination after retort sterilization at 100° C. to 120° C. for 5 to 15 min. The layered/composite exhibits no delamination after boil sterilization at 90° C. to 100° C. for 30 to 120 min.

### II. Process of Synthesis of Water-Soluble Co-Polyester Polymers

The present invention also discloses a process of synthesis of a water-soluble co-polyester polymer.

The present invention discloses a process of synthesis of a water-soluble co-polyester polymer; the process comprising polymerizing a) a pre-polymer (A); and b) a tricarboxylic acid; wherein, the pre-polymer (A) comprises a transesterification reaction product of a dicarboxylic acid or ester thereof with a diol.

The present invention discloses a process of synthesis of a water-soluble co-polyester polymer; the process comprising the steps of: a) synthesizing a pre-polymer (A); and b) polymerizing pre-polymer (A) with a tricarboxylic acid.

### A. Synthesis of Pre-Polymer (A)

The pre-polymer (A) is synthesized by carrying out transesterification reaction between a dicarboxylic acid and a diol.

The dicarboxylic acid and the diol may be one dicarboxylic acid and one diol; or can be a mixture of dicarboxylic acids and diols.

The dicarboxylic acid and the diol are selected may be one dicarboxylic acid and diol respectively or a mixture of dicarboxylic acids and diols. The dicarboxylic acid or ester thereof is selected from an aliphatic dicarboxylic acid, an aliphatic dicarboxylate, a cycloaliphatic dicarboxylic acid, a cycloaliphatic dicarboxylate, an aromatic dicarboxylic acid, an aromatic dicarboxylate or any combination thereof The non-limiting examples of dicarboxylic acids include isophthalic acid, dimethyl isophthalate, terephthalic acid, dimethyl terephthalate, sebacic acid, dimethyl 2,6-naphthalate, naphthalene dicarboxylic acid, dimethyl 1,4-naphthalate, succinic acid, adipic acid, azelaic acid, 2,6-naphthalene dicarboxylic acid, glutaric acid, maleic acid, fumaric acid, oxalic acid, malonic acid, pimelic acid, suberic acid or any combination thereof Preferably, the dicarboxylic acid is selected from isophthalic acid, dimethyl isophthalate, terephthalic acid, dimethyl terephthalate or any combination thereof.

In some embodiments, one dicarboxylic acids are used. In some embodiments, the dicarboxylic acids are used in mixture. In one embodiment, the dicarboxylic acids are selected from aromatic dicarboxylic acid. In one embodiment, the dicarboxylic acids are selected from dimethyl terephthalate, pure terephthalate, isophthalic acid, ortho-phthalic acid, dimethyl 2,6-naphthalate and naphthalene di-carboxylic acid. The aromatic di-carboxylic acid is used from 1 to 100 mole %; preferably from 10 to 80 mole %; more preferably from 10 to 60 mole %. In one embodiment, the dicarboxylic acids are selected from aliphatic dicarboxylic acid. In one embodiment, the dicarboxylic acids are selected from suberic acid, adipic acid, oxalic acid. The aliphatic dicarboxylic acids are used from 1-100 mole %; preferably from 5 to 80 mole %.

In some preferred embodiments, the dicarboxylic acid is a combination of isophthalic acid, terephthalic acid and sebacic acid.

The first diol is selected from ethylene glycol, 1,2-propanediol, 1,3-propanediol,1,3-butanediol,1,4-butanediol,1,5-pentanediol,1,6-hexanediol, neopentyl glycol, diethylene glycol, polyethylene glycol, polypropylene glycol, polytetramethylene glycol and 1,4-cyclohexanedimethanol. The first diols are used from 1 to 100 mole %; preferably from 5 to 80 mole %.

In some preferred embodiments, the diol is a combination of ethylene glycol, butane diol and neopentyl diol.

The transesterification reaction is carried out in presence of one or more catalyst. The catalyst system is selected from antimony trioxide a titanium-based catalyst; preferably, the catalyst is Antimony trioxide. The catalyst is used in monomer slurry at a concentration ranging from 1 to 1000 ppm; preferably from 10 to 600 ppm.

The transesterification reaction is carried out in presence of one or more heat stabilizer. The heat stabilizer is selected from orthophosphoric acid or poly phosphoric acid; preferably poly phosphoric acid from 1 to 1000 ppm; more preferably from 10 to 600 ppm.

The temperature of the transesterification reaction is maintained from 200° C. to 300° C.; preferably from 240° C. to 280° C.

For synthesis of pre-polymer (A) the transesterification reaction is carried out from 2 to 5 Hr; preferably from 2 to 4 Hr. The catalyst and heat stabilizer added in slurry mixture. After transesterification was complete, which was confirmed by removal of quantity of water.

### B. Polymerization of Pre-polymer (A) and Tricarboxylic Acid

The process of synthesizing water-soluble co-polyester polymer of the present invention; the process comprises polymerizing the pre-polymer (A) and a tricarboxylic acid.

The pre-polymer (A) and the tricarboxylic acid were taken in a Wt. % from 1 to 100% by w/w and 2-60% by weight respectively.

In some preferred embodiments, the tricarboxylic acid is trimellitic acid.

The polymerization reaction is carried out in vacuum.

The polymerization reaction was carried out for about 2 to 2.5 Hr; preferably 2 to 4 Hr.

The temperature of the polymerization reaction was maintained from 220° C. to 350° C.; preferably from 230° C. to 290° C.

The process of synthesis disclosed in the present invention wherein the polymer synthesized by the process is used to coat one or more substrates. The substrates include but not limited to BOPET film, BOPET primer for metallization and Aluminum sheets.

The process of synthesis disclosed in the present invention wherein the polymer synthesized by the process can be coated on the BOPET film during inline manufacturing process.

The process of synthesis disclosed in the present invention wherein the polymer synthesized by the process imparts excellent surface characteristics to the coated surface e.g. surface property by increasing number of free functional group for further reaction, adhesion, printability, metal to film bond strength etc. The polymer of the present invention also coats the surface very efficiently in minimum weight gain.

The process of synthesis disclosed in the present invention wherein the polymer synthesized by the process can be printed using a wide range of ink systems e.g. water-based inks and solvent-based ink system. The polymer of the present invention is also used with the UV curable inks to coat the surface of the substrates.

The polymer synthesized by the process disclosed herein exhibits an intrinsic viscosity (I.V.) from about 0.1 to 0.5 dL/g. Preferably, the polymer exhibits an intrinsic viscosity (I.V.) from about 0.1 to 0.45 dL/g. More preferably, the polymer exhibits an intrinsic viscosity (I.V.) from about 0.1 to 0.4 dL/g.

The polymer synthesized by the process exhibits a carboxylic content from 30 to 900 meq/Kg. Preferably, the polymer exhibits a carboxylic content from 30 to 850 meq/Kg. More preferably, the polymer exhibits a carboxylic content from 30 to 800 meq/Kg.

The polymer synthesized by the process disclosed herein exhibits a glass transition temperature from 30° C. to 50° C. Preferably, the polymer exhibits a glass transition temperature from 30° C. to 45° C. More preferably, the polymer exhibits a glass transition temperature from 30° C. to 40° C.

The polymer synthesized by the process disclosed herein when coated over a 12 micron BOPET film in inline manufacturing process, the coating is done at 0.01 to 0.09 GSM. Preferably, the coating is done at 0.01 to 0.08 GSM. More preferably, the coating is done at 0.01 to 0.07 GSM.

The polymer synthesized by the process disclosed herein when coated over a 12 micron BOPET film at a coating thickness from 0.01 to 0.09 GSM and then the coated BOPET film is printed, the coated and printed BOPET film exhibits resistance to ink adhesion test in Tape Test after sustaining boiling water test for 2 hr. Preferably, the coated and printed BOPET film exhibits resistance to ink adhesion test in Tape Test after sustaining boiling water test for 1 hr.

More preferably, the coated and printed BOPET film exhibits resistance to ink adhesion test in Tape Test after sustaining boiling water test for 0.5 hr.

The polymer synthesized by the process disclosed herein when coated over a 12 micron BOPET film at a coating thickness from 0.01 to 0.09 GSM, then the coated BOPET film is vacuum metallized with Aluminum with an optical density from 0.5 to 3.2. Preferably, the coated film is metallized with Aluminum with an optical density from 1.5 to 3.2. More preferably, the coated film is metallized with Aluminum with an optical density from 1.8 to 3.2.

The polymer synthesized by the process disclosed herein when coated over a 12 micron BOPET film 0.01 to 0.09 GSM and then the coated BOPET film is vacuum metallized with Aluminum exhibits a metal to film bond strength from 800 g/inch to 1,200 g/inch. Preferably, the metallized film exhibits a metal to film bond strength from 800 g/inch to 1,100 g/inch. More preferably, the metallized film exhibits a metal to film bond strength from 800 g/inch to 1,000 g/inch.

The polymer synthesized by the process disclosed herein when coated over a 12 micron BOPET film 0.01 to 0.09 GSM and then the coated BOPET film is printed with various retort ink(s), the printed film is then subjected to lamination with Aluminum foil, retort cast polypropylene film, nylon film and with retort adhesive sequentially to make composite film, the resulted composite film exhibits no delamination after retort sterilization at 100° C. to 120° C. for 5 to 15 min. The composite film exhibits no delamination after boil sterilization at 90° C. to 100° C. for 30 to 120 min

Typical experiments of the polymer of the present invention are given in table-1. The evaluation characteristics of the polymers synthesized, coated PET film, vacuum metallized PET film are given in tables 2 to 5.

### General Procedures

Synthesis of Water-Soluble Co-Polyester Polymer:

### Procedure

Step: 1: Synthesis of Pre-polymer (A): Dicarboxylic acids and diols were taken together in a reactor vessel. The catalyst Antimony Trioxide and heat stabilizer poly phosphoric acid were added in a concentration ranging from 10 to 600 ppm and 5 to 600 ppm respectively. The reactants were allowed to react for about 2 to 3.5 hr at a temperature ranging from 240° C. to 280° C. The reaction completion was validated by the removal of water.

Step: 2: Synthesis of Polymer: The pre-polymer (A) and tricarboxylic acid were added in a reaction vessel. The vacuum was applied to the reaction. Then, the pre-polymers were allowed to react for about 2.5 to 4 hr at a temperature ranging from 230° C. to 290° C.

Typical formula of the polymer of the present invention are given in table-1. Different polymers were synthesized through general procedures given herein.

For formula 1 to 6 isophthalic acid, pure terephthalic acid and sebacic acid were taken as carboxylic acids; ethylene glycol, 1,4-butane diol and neopentyl glycol were taken as the diol. Trimellitic acid was taken as tricarboxylic acid.

Different batches of the polymer of the present inventions were synthesized and evaluated. The evaluation characteristics of the polymers synthesized, coated PET film, vacuum metallized BOPET film and composite film are given in tables 2-5.

TABLE 1
Formulation of typical example of the polymer of the present invention

| | Wt. % | | | | | | |
|---|---|---|---|---|---|---|---|
| Formula | PTA | IPA | SA | EG | BD | NPG | TMA |
| 1 | 32.0 | 8.4 | 3.6 | 13.1 | 15.1 | 21.8 | 6.0 |
| 2 | 40.48 | 10.58 | 5.56 | 6.20 | 10.31 | 17.28 | 9.6 |
| 3 | 39.32 | 10.27 | 5.40 | 7.29 | 10.02 | 16.78 | 10.93 |
| 4 | 37.80 | 10.53 | 5.54 | 7.47 | 10.27 | 17.20 | 11.20 |
| 5 | 37.98 | 10.71 | 5.63 | 7.60 | 10.45 | 17.50 | 10.13 |
| 6 | 40.80 | 10.66 | 5.61 | 7.56 | 10.40 | 17.41 | 7.56 |

### C. Coating of the Present Polymer on BOPET Film

### (i) Preparation of Coating Solution:

A solution of polymer of the present invention is prepared by dissolving a weighed quantity (10% w/v) of the polymer in a solvent mixture water: Isopropyl Alcohol (90:10) at 90° C. with agitation in a water cooled condenser tank for about 2-4 Hr. In some samples crosslinking agent melamine resin (Cymel 325 or Cymel 327) was added in a range from 1.5-5 weight %. In some other examples of Aziridine crosslinking agent (CX 100) was taken as a crosslinking agent. The pH of the solution was adjusted with liquid ammonia.

### (ii) Coating of BOPET Films

BOPET films were coated with the solution of the polymer of the present invention by in-line polyester film manufacturing after machine direction orientation and before transverse direction orientation. The coated with films were further subjected to transverse orientation with crystallization and drying process at temperature range of 80° C. to 240° C. with 1.5 to 5 times stretching. Polymers of the present invention were coated inline with horizontal gravure kiss coating system during manufacturing of BOPET films. The coating thickness maintained from 0.01 to 0.09 GSM.

### D. Preparation of Layered/Composite Film:

A layered/composite film was made by coating the BOPET film with the polymer of the present invention (at a coating thickness from 0.01 to 0.09) in inline manufacturing process. The coated film is then printed with various retort ink(s), the printed film is then laminated with Aluminum foil, retort cast polypropylene film, nylon film and with retort adhesive sequentially to make composite film. The layered/composite film was made by the methods and procedures known in the relevant art. This layered/composite films were subjected to retort test.

### III. Evaluations

The water-soluble co-polyester polymers disclosed herein were synthesized and evaluated for various quality characterstics. These characterstics includes intrinsic viscosity (I.V.), carboxylic end group content, glass transition temperature (T_{g}), tensile strength, thermal shrinkage, haze, sufrace energy, co-efficient of friction, coating thickness, boiling test for ink removal, metallization efficiency, optical density, metal to film bond strength, water vapour transmission rate (WVTR), oxygen transmission rate (OTR) and retort sterlization. Average test results are given in the tables 2 to 5.

### A. Evalutation of Water-Soluble Co-Polyester Polymer

### (i) Intrinsic Viscosity:

Intrinsic viscosity was measured by dissolving 0.25 gm±0.002 g co-polyester polymer in a solvent system of phenol and 1,1,2,2 tetrachloro ethane (60:40 w/w) using Ubbelohde capillary viscometer. The results for water-soluble polymers synthesized as per the present invention are given given in table-2.

### (ii) Carboxylic End Group (—COOH) Content:

Carboxylic end group content measurement was done using approximate 1.0±0.02 g of co-polyester dissolved in solvent system Phenol: Chloroform (50:50 w/w). The resultant solution was titrated with 0.02 N Benzyl-KOH. Approx. 4 drops of bromophenol blue were used as indicator. The results for water-soluble polymers synthesized as per the present invention are given given in table-2.

(iii) Glass Transition Temperature (T_{g}):

Glass transition temperature (T_{g}) was tested by differential scanning calorimetry (DSC). The results for water-soluble polymers synthesized as per the present invention are given given in table-2.

### (iv) Colour Test:

Colour was tested by using HunterLab® apparatus. The results for water-soluble polymers synthesized as per the present invention are given given in table-2.

TABLE 2
Evaluation results for the polymer
disclosed in the present invention

| | | Unit of | |
|---|---|---|---|
| Quality characteristics | | Measurement | Readings |
| Intrinsic Viscosity (I.V.) | | dL/g | 0.1 to 0.5 |
| (—COOH) End group | | meq/Kg | 30 to 900 |
| Glass Transition | | ° C. | 30 to 50 |
| Temperature (T_{g}) | | | |
| Color | L* | — | 40 to 80 |
| Value | a* | — | −0.1 to 7.0 |
| | b* | — | −3 to 12 |

B. Evalutation of 12 Micron BOPET Film Inline Coated with Polymers of the Present Invention

### (i) Tensile Strength:

The tensile properties were measured by using universal tensile machine (UTM) as per ASTM D882. The results given given in table-3.

(ii) Thermal Shrinkage:

Thermal shrinkage of film was measured according to ASTM D2838, where in samples were cut in required sizes (254 mm×254 mm), initial dimensions were measured and marked as Machine Direction (MD) and Transverse Direction (TD) on the sample, which were placed in an oven at 150° C. for 30 min. The sample were taken out after 30 min. and allowed to cool at room temperature. The final dimensions of sample were measured again to check the shrinkage. The results are given given in table-3

(iii) Haze and Transmittance:

Haze % and transmittance % of the film is measured by using a Haze meter or by a spectrophotometer, according to ASTM D1003. The results are given given in table-3.

### (iv) Surface Energy:

Surface energy was tested as per the ASTM D 2578 standard. The results are given given in table-3.

### (v) Co-Efficient of Friction:

The co-efficient of friction was tested as per the ASTM D 1894 standard. The results are given given in table-3

### (vi) Coating Thickness:

Coating thickness was measured by gm/m². In order to determine coating thickness, samples were cut in the size of 100×100 mm templates and their weight were measured using weighing balance having accuracy of 0.001 gm. Thereafter, the coating of the film was removed by suitable solvent and the samples are weighed again. The difference of weight of the sample was used to measure coating thickness using following formula. Average GSM=[(weight difference of sample in g)/(length in meter×width in meter)]. The results are given given in table-3.

(vii) Boiling Water Test and Ink-Adhesion Test:

The coated films were printed with one to six colors in a conventional gravure printing machine using solvent-based ink. The printed films were then kept on a glass container at 90 to 100° C. in boiling water for about 2 hr. Then the films were dried and checked for tape test using 3M tape number 610 for ink adhesion test. A conventional corona treated BOPET film was also carried out for the same test. The results are given given in table-3.

TABLE 3
Evaluation results for the 12 micron BOPET coated
with the polymer disclosed in the present invention

| | | Polymer of the | 12 microns |
|---|---|---|---|
| | Unit of | present | corona treated |
| Test | Measurement | invention | BOPET |
| Tensile strength | Kg/cm² | 1600 to 2500 | 1600 to 2500 |
| MD and TD- | | | |
| ASTM D 882 | | | |
| Thermal- | % | 1-3 in MD, | 1-3 in MD, |
| Shrinkage MD | | 0-1 in TD | 0-1 in TD |
| and TD- | | | |
| ASTM D 1204 | | | |
| Haze-ASTM D | % | 1 to 5 | 1 to 5 |
| 1003 | | | |
| Surface Energy- | Dyne/cm | 46 to 52 | 50 to 56 |
| ASTM D | | | |
| 2578 | | | |
| Co-efficient | — | 0.45-0.7 | 0.45-0.7 |
| of Friction- | | Static, | Static, |
| Static and | | 0.4-0.65 | 0.4-0.65 |
| Dynamic- | | Dynamic | Dynamic |
| ASTM D 1894 | | | |
| Coating GSM | g/m² | 0.01 to 0.09 | — |
| Ink adhesion | — | No ink | Complete |
| test for 2 hrs | | removed | Ink |
| in boiling water | | | removed |

C. Evalutation of 12 Micron BOPET Film Inline Coated with Polymers (0.010 to 0.09 GSM) then Vacuum Metallized with Aluminum Metal

### (i) Optical Density:

Optical density was tested using Tobias instrument. The results are given given in table-4.

(iii) Metal to Film Bond Strength:

Metal to film bond strength was measured by AIMCAL standard. The results are given given in table-4.

(iv) Water Vapor Transmission Rate (WVTR):

Water Vapor Transmission Rate (WVTR) of metallized film was evaluated as per ASTM F372 by using MOCON PERMATRAN 3/33 at the test condition of 38° C. and 90% RH (Relative Humidity). The results are given given in table-4.

(v) Oxygen Transmission Rate (OTR):

Oxygen transmission rate (OTR) of metallized film was evaluated according to ASTM D 3985 using MOCON OXTRAN 2/21 instrument at test condition of 23° C and 0% Relative Humidity (RH). The results are given given in table-4.

TABLE 4
Evaluation results for the 12 micron BOPET coated
with the polymer then metallized with Aluminum

| | Unit of | Polymer of the present |
|---|---|---|
| Quality Parameter | Measurement | invention |
| GSM | g/m² | 0.01 to 0.09 |
| Optical Density | — | 0.5 to 3.2 |
| Metal to film bond Strength | gm/inch | 800 to 1,200 |
| (AIMCAL test procedure) | | |
| WVTR (38° C. & 90% RH) | gm/m²/day | 0.2 to 2.5 |
| OTR (23° C. & 0% RH) | cc/m²/day | 0.2 to 3.0 |

### (vi) Retort Sterilization:

The in-line coated film of polymer of the present invention were subjected to retort test. The coating GSM used in making retort laminate ranges about 0.01 to 0.09.

TABLE 5
Evaluation results for Retort sterilization

| | Time | | Polymer of the present |
|---|---|---|---|
| Temp. (° C.) | (min) | Retort Type | invention |
| 100 to 120 | 5 to 15 | Retort Sterilization | No delamination |
| | | | observed |
| 90 to 100 | 30 to 120 | Boil Sterilization | No delamination |
| | | | observed |

### IV. Observation and Conclusion

The results showed that the polymer of the present invention coated the substrates BOPET films in very less weight gain (very less GSM) i.e. 0.01 to 0.09 GSM. Further, the metal to film bond offered by the polymer of the present invention was very strong. The polymer of the present invention also showed excellent printability with boiling water resistant and retort resistant. The polymer of the present invention can be used for inline coating BOPET films and for BOPET film primer for metallization. The thin coating and boiling water test also make the polymer eligible for coating Aluminum sheets used to manufacture Aluminum cans to offer better printability. The polymer of the present invention is also good for retort packaging. The most important thing is that the polymer of the present invention can be used with water-based ink systems as well as solvent-based ink systems.

The present description is the best presently-contemplated polymers and process for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

What is claimed is:

1. A water-soluble co-polyester polymer; the polymer comprises:
(a) a pre-polymer (A); and
(b) a tricarboxylic acid;
wherein:
the pre-polymer (A) comprises a transesterification reaction product of a dicarboxylic acid or ester thereof with a diol.

2. (canceled)

3. (canceled)

4. The polymer of claim 1, wherein the dicarboxylic acid is a combination of isophthalic acid, terephthalic acid and sebacic acid.

5. (canceled)

6. (canceled)

7. The polymer of claim 1, wherein the diol is a combination of ethylene glycol, butane diol and neopentyl glycol.

8. The polymer of claim 1, wherein the tricarboxylic acid is trimellitic acid.

9. The polymer of claim 1, wherein the polymer is used for inline coating of BOPET film manufacturing, coating of BOPET film used as primer for vacuum metallization, surface coating of Aluminum sheets.

10. The polymer of claim 1, wherein the polymer exhibit at least one of:
a) an intrinsic viscosity (I.V.) from 0.1 to 0.5 dL/g;
b) a carboxylic end group content from 30 to 900 meq/Kg; and
c) a glass transition temperature from 30° C. to 50° C.

11. The polymer of claim 1, wherein a 12 micron BOPET film inline coated with the polymer exhibit at least one of:
a) a coating at 0.01 to 0.09 GSM; and
b) a resistance to ink adhesion in Tape Test after sustaining boiling water test for 0.5 to 2 hr.

12. The polymer of claim 1, wherein a 12 micron BOPET film inline coated with the polymer and then vacuum metallized with Aluminum at a range of optical density from 0.5 to 3.2, exhibit a metal to film bond strength from 800 g/inch to 1200 g/inch.

13. The polymer of claim 1, wherein a wherein a 12 micron BOPET film inline coated with the polymer of any of the claims 1 to 15 and then the coated BOPET film is printed with one or more retort inks, the printed film is then subjected to lamination with Aluminum foil, retort cast polypropylene film, nylon film and with retort adhesive sequentially to make layered/composite film, the layered/composite film exhibits at least one of:
a) no delamination after retort sterilization at 100° C. to 120° C. for 5 to 15 min; and
b) no delamination after boil sterilization at 90° C. to 100° C. for 30 to 120 min.
